(19) United States
(12) Patent Application Publication
(10) Pub. No.: US 2006/0076226 A1
(43) Pub. Date: Apr. 13, 2006

(54) Machine for desalinating salt water, brine water and impure water and the process for making same and a plant for making same

(76) Inventor: Michael Thomas Marcellus, Aurora, IL (US)

Correspondence Address: Michael T. Marcellus, 2610 Ryder Ct., League City, TX, 77573, US

(21) Appl. No.: 10/960,334

(22) Filed: Oct. 7, 2004

(51) Int. Cl. C02F 1/04; B01D 3/00

(52) U.S. Cl. 203/10; 203/DIG. 17; 203/DIG. 1; 202/234; 159/903

(57) ABSTRACT

A machine for desalinating salt water, brine water and impure water by using a desalination panel comprised of a main body of panel (Black in color), lower end cap (Black in color), upper end cap (Black in color), vapor filter unit, vapor porous hydrophobic membrane cartridge, vapor porous hydrophobic membrane cartridge retaining bracket, center section plug, and float level hole. Salt water floods bottom of panel then continues to flow up and over into top section of panel where sun exposure causes heat to generate water vapor that passes through vapor filter unit into center section of panel where it condenses into potable water. Troth in center section directs potable water down to lower end cap for drawing off for use. A series of panels that are connected by a manifold type system constitutes a plant of panels which generates larger quantities of potable water.

### CROSS REFERENCE TO RELATED APPLICATIONS

Not Applicable

### STATEMENT REGARDING FEDERALLY SPONSORED RESEARCH OR DEVELOPMENT

Not Applicable

Description of Attached Appendix

Not Applicable

### BACKGROUND OF THE INVENTION

This invention relates generally to the field of water distillation and more specifically to a machine for desalinating salt water, brine water and impure water and the process for making same.

For many years, people have invented various ways to use sun exposed panels that are filled with salt water to generate water vapor that can be condensed into potable water. So far they seem to be very complicated, difficult to manufacture and somewhat fragile. In the preferred embodiment of this invention, this invention is easy to manufacture (all parts can be made from recycled plastics except for membrane), easy to assemble, robust and easy to use in conjunction with other desalination panels to make a larger racks of desalination panels to complete a system that constitutes a plant that can develop larger quantities of potable water. The panels on these racks can be joined together by the use of a manifold type system to allow the three chambers of each panel to work in unison to create large manufacturing, solar powered, potable water generating plants.

### REFERENCES CITED

U.S. Patent Documents

| | |
|---|---|
| Patent 6,797,124: Ludwig | Sep. 28, 2004. |
| Patent 6,679,991: Van Andel | Jan. 20, 2004. |
| Patent 6,656,326: Nagler | Dec. 2, 2003. |
| Patent 6,440,275: Domen | Aug. 27, 2002. |
| Patent 6,391,162: Kamiya et al. | May 21, 2002. |
| Patent 6,274,004: Andersen | Aug. 14, 2001. |
| Patent 5,672,250: Ambadar et al. | Sep. 30, 1997. |
| Patent 4,966,655: Wilkerson | Oct. 30, 1990. |
| Patent 4,545,862: Gore et al. | Oct. 8, 1985. |

### BRIEF SUMMARY OF THE INVENTION

The primary object of the invention is to generate potable water from salt water, brine water and impure water.

Another objective of the invention is to show how these panels can be used in a multi-paneled rack to generate large quantities of potable water.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for desalinating salt water, brine water or impure water comprising: main body of panel (Black in color), made from recycled plastic; lower end cap (Black in color), made from recycled plastic; upper end cap (Black in color), made from recycled plastic; vapor filter unit, made from recycled plastic; vapor porous hydrophobic membrane cartridge; vapor porous hydrophobic membrane cartridge retaining bracket, made from recycled plastic; center section plug, made from recycled plastic; and float level valve hole.

In accordance with a preferred embodiment of the invention, there is disclosed a process for desalinating salt water, brine water or impure water comprising the steps of: flood lower section of desalination panel assembly with salt water, brine water or impure water (Supply water), allow supply water to flow into top section of desalination panel assembly (FIG. 3 flood pattern), float valve will shut down flow to lower section when the supply water reaches a specific level in upper section of panel, expose desalination panel assembly to the sun, vapor generated by the heat of the sun will pass through the vapor porous filter unit into center section, vapor will condense against lower surface of center section due to the supply water in lower section of panel acting as a heat sink, condensed potable water will gather in troth of center section where it will be directed towards lower end cap, the potable water will be drawn off from the center section lower end cap nozzle.

Multiple panels connected together by a manifold type system constitutes a plant to generate large quantities of potable water.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the pulltruded main body of panel.

FIG. 3 is a cross sectional view of the invention.

FIG. 4 is a cut away view of the invention.

FIG. 5 is a perspective view of the outside view of lower end cap.

FIG. 6 is a perspective view of the inside view of lower end cap.

FIG. 7 is a perspective view of upper end cap.

FIG. 8 is a perspective view of the center section plug.

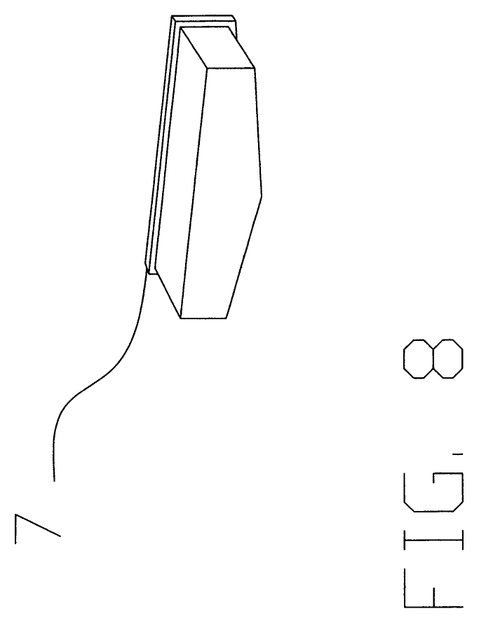

FIG. 9 is a perspective view of the vapor filter unit.

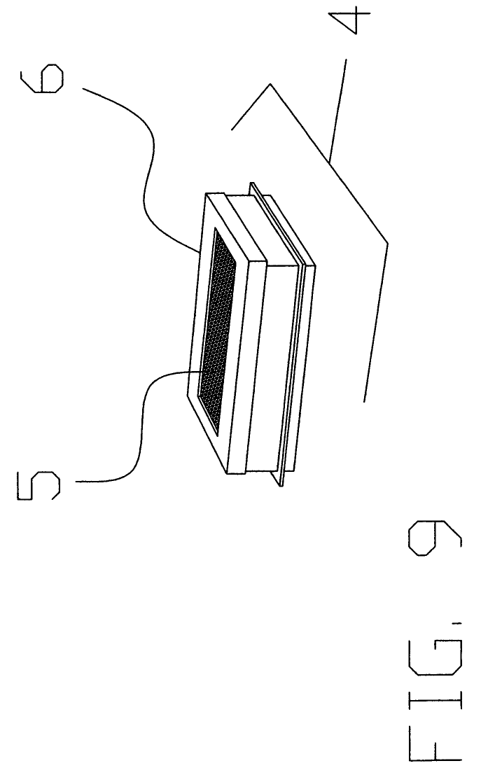

FIG. 10 is a perspective view of panels laid side-by-side to constitute a plant of said panels including solar panel layout.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

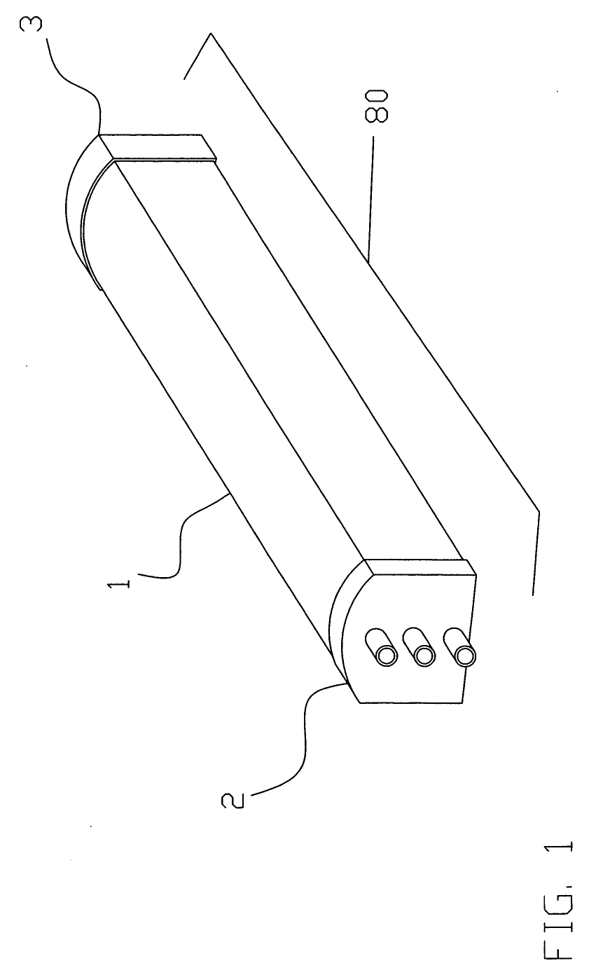

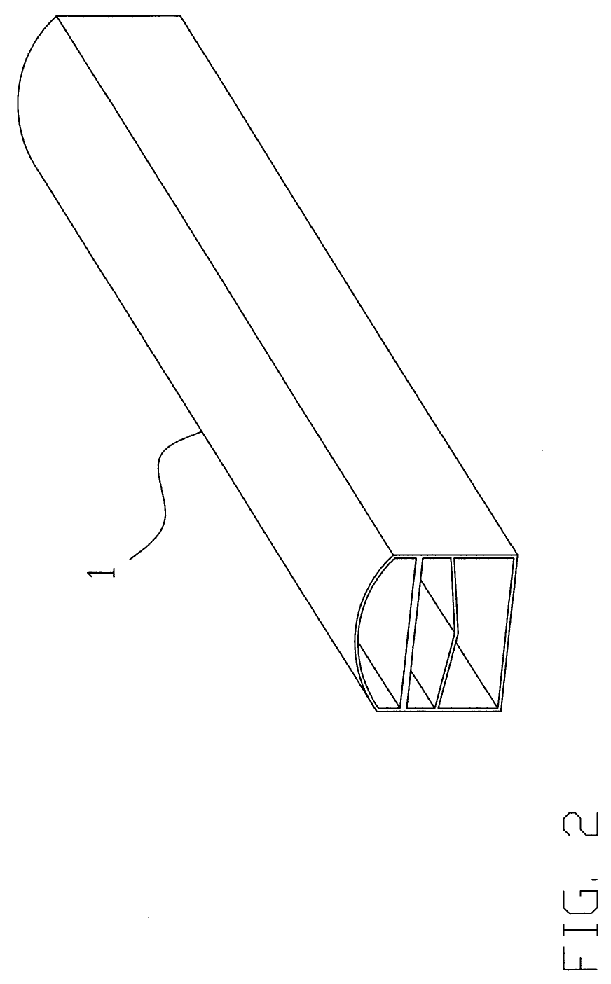

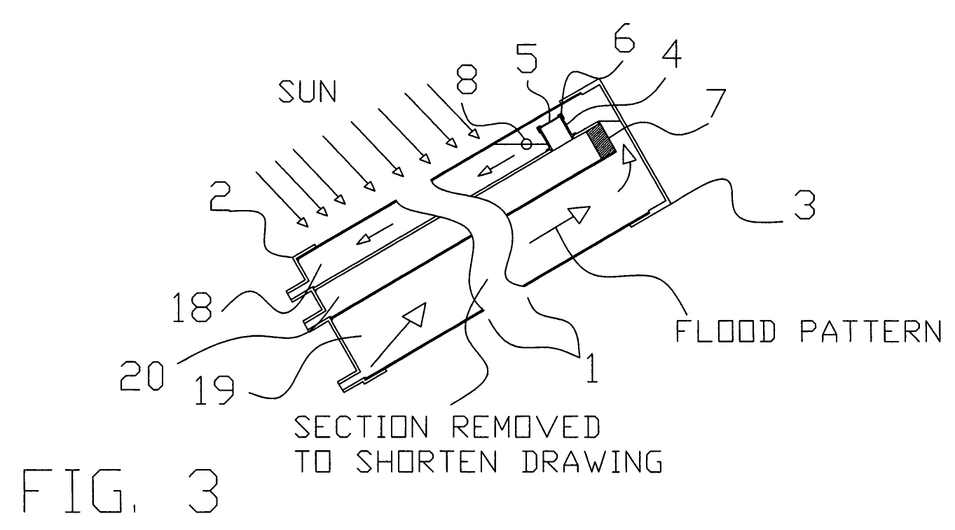

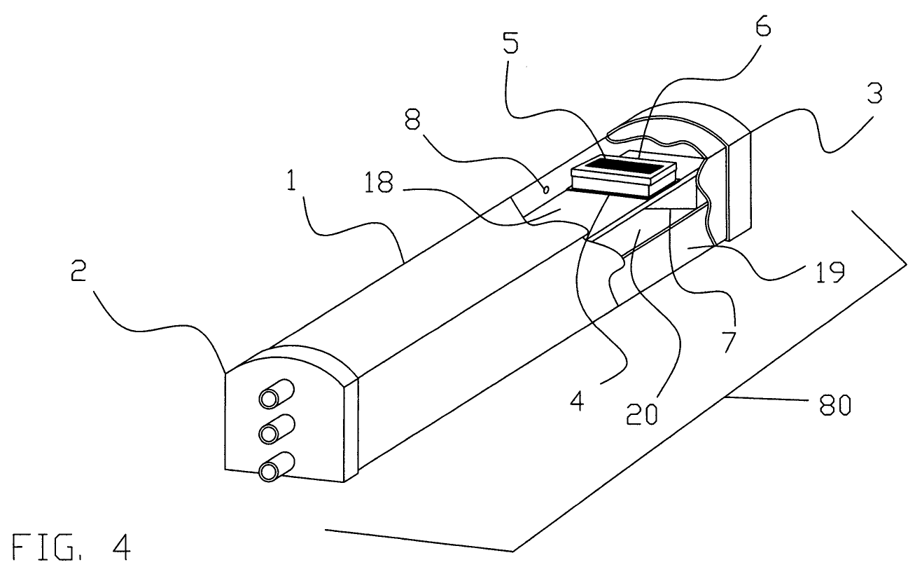

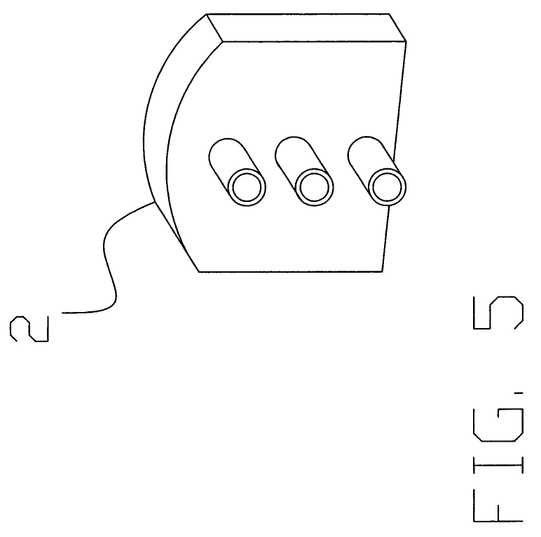

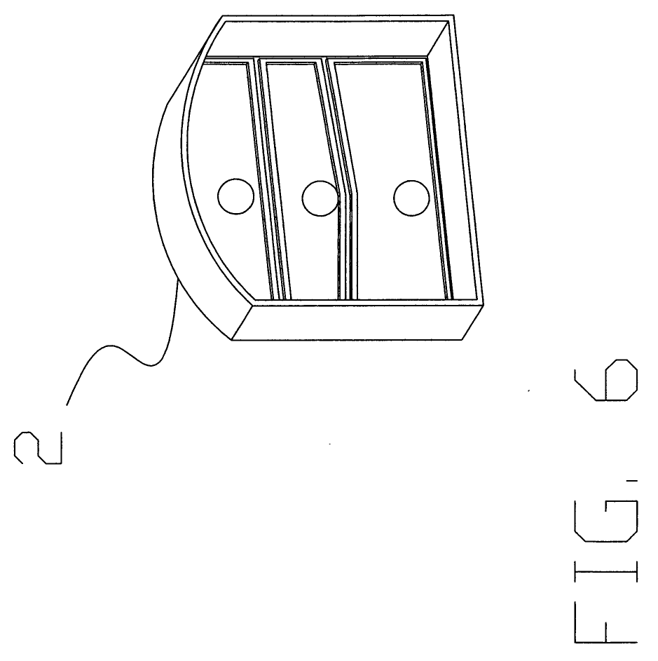

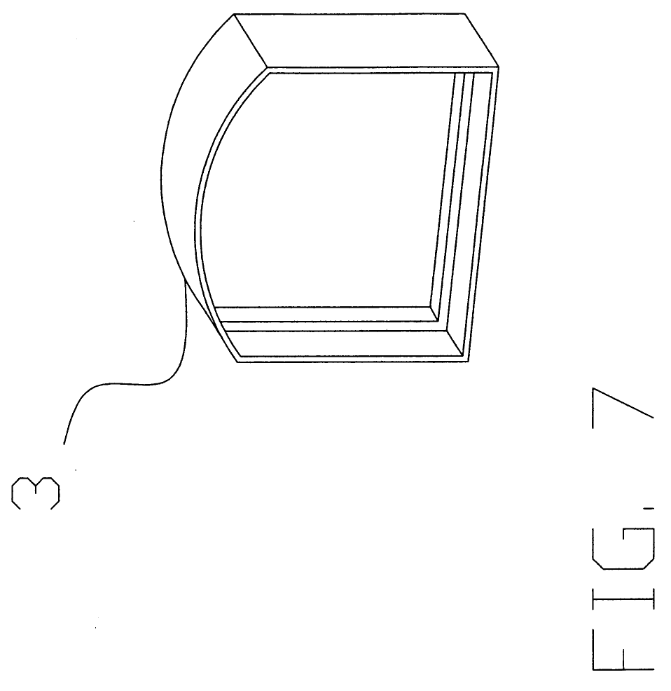

In accordance with a preferred embodiment of the invention (FIG. 1, 80), there is disclosed a machine for desalinating salt water, brine water or impure water comprising: main body of panel (Black in color) ((FIGS. 1, 2, 3, 4, & 10), 1), lower end cap (Black in color) ((FIGS. 1, 3, 4, 5, 6, & 10), 2), upper end cap (Black in color) ((FIGS. 1, 3, 4, 7, & 10), 3), vapor filter unit ((FIGS. 3, 4, 7 & 10), 4), vapor porous hydrophobic membrane cartridge (VPHMC) ((FIGS. 3, 4,9 & 10) 5), VPHMC retaining bracket ((FIGS. 3,4,9 & 10), 6), center section plug ((FIGS. 3,4 & 8), 7), and float level valve opening ((FIGS. 3 & 4), 8).

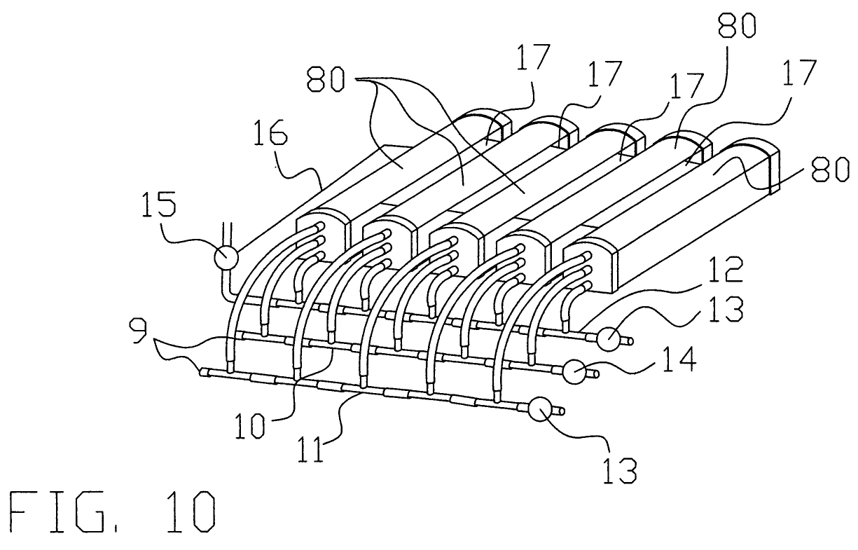

In accordance with a preferred embodiment of the invention, there is disclosed a process for desalinating salt water, brine water or impure water comprising the steps of: flood lower section (19) of desalination panel assembly (80) with salt water, brine water or impure water (Supply water), allow supply water to flow into upper section (18) of desalination panel assembly, float valve (Industrial available unit, not shown in figures) will shut down flow to lower section (19) by shutting off supply valve (FIG. 10, 15) when the supply water reaches a specific level in upper section of panel, expose desalination panel assembly to the sun, vapor generated by the heat of the sun will pass through the vapor porous filter unit (4) into center section (20), vapor will condense against lower surface of center section due to the supply water in lower section (19) of panel acts as a heat sink, condensed potable water will gather in troth of center section where it will be directed towards lower end cap (2), the potable water will be drawn off from the center section lower end cap nozzle. As vapor is taken from upper section (18) supply water of panel (80) the water level in the upper section (18) will drop. When the level of supply water reaches a specific low level point the float valve opens up to supply valve (FIG. 10, 15) to allow more water to lower section (19) thus continuing the cycle of production of potable drinking water.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for desalinating salt water, brine water or impure water comprising:
1. main body of panel (Black in color) can be made from recycled plastic using pulltrusion technology;
2. lower end cap (Black in color) can be made from recycled plastic;
3. upper end cap (Black in color) can be made from recycled plastic;
4. vapor filter unit which can be made from recycled plastic;
5. vapor porous hydrophobic membrane cartridge;
6. vapor porous hydrophobic membrane cartridge retaining bracket can be made from recycled plastic; and
7. center section plug, which can be made from recycled plastic.

2. A process for desalinating salt water, brine water or impure water comprising the steps of:
1. flood lower section of desalination panel assembly with salt water, brine water or impure water (Supply water);
2. allow supply water to flow into top section of desalination panel assembly;
3. float valve will shut down flow to lower section when the supply water reaches a specific level in upper section of panel;
4. expose desalination panel assembly to the sun;
5. vapor generated by the heat of the sun will pass through the vapor porous filter unit into center section;
6. vapor will condense against lower surface of center section due to the supply water in lower section of panel acts as a heat sink;
7. condensed potable water will gather in troth of center section where it will be directed towards lower end cap;
8. the potable water will be drawn off from the center section lower end cap nozzle.

3. A rack of panels laid side-by-side and connected by a manifold type system constitutes a plant.
Each section of the panels, when connected by a manifold type system ((FIGS. 10), 10,11 & 12) will work in unison to generate larger quantities of potable water in the same amount of time when exposed to the sun. With the panels (FIG. 10, 80) exposed to the sun solar cells can be used in unison to generate any power needed to run subsequent systems of said plant (FIG. 10, 17).
The components of the plant are in FIG. 10. Panel Assemblies (80), Manifold end caps (9), potable water manifold (10), top section manifold (11), lower section manifold (12), drain purge valves (13) for flushing system, potable water valve (14), Supply valve controlled by float level (15 & 16)(Electrical solenoid valve and float valve) and solar panel arrays (17) which can be added to supply any electricity needed to run said plant.
